(19) United States
(12) Patent Application Publication
(10) Pub. No.: US 2014/0272901 A1
(43) Pub. Date: Sep. 18, 2014

(54) METHODS AND APPARATUS FOR PROVIDING ALTERNATIVE EDUCATIONAL CONTENT FOR PERSONALIZED LEARNING IN A CLASS SITUATION

(71) Applicant: Alcatel-Lucent, Paris (FR)

(72) Inventors: Abdelkrim HEBBAR, Orsay (FR); Myriam RIBIERE, Montlhery (FR)

(73) Assignee: Alcatel-Lucent, Paris (FR)

(21) Appl. No.: 13/828,329

(22) Filed: Mar. 14, 2013

(51) Int. Cl. G09B 5/08

(52) U.S. Cl. CPC G09B 5/08
USPC 434/362

(57) ABSTRACT

In one example embodiment, the learning content management system includes a processor configured to determine a local level of understanding for a learning object based on a plurality of received inputs. The local level of understanding indicates a collective understanding level of the learning object by a plurality of users. Each of the plurality of received inputs indicates a level of understanding of the learning object by one of the plurality of users. The processor is further configured to determine a global level of understanding based on the determined local level of understanding.

### BACKGROUND

Many studies have been conducted to illustrate a problem related to a learning gap in a level of understanding (LoU) achieved by different students or trainees in a teaching setting such as a classroom conducted by an instructor. In an attempt to address this problem and to narrow the gap, educational systems have been developed that provide personalized learning and adaptive educational content to students/learners.

However, existing solutions only create and provide relevant educational content based on a set of predetermined criteria received from a user. For example, such systems initially take into account a user's study goals and/or unique preferences and accordingly provide the user with educational content. Another existing solution provides for personalization of learning content based on a profile initially built from personal information, points of interest and current skill levels of students/learners. Moreover, such system computes a probability for the most appropriate subsequent learning object based on observing past actions of a student/learner, where the subsequent learning object may be a subject matter or a supplemental educational content related to the educational content.

However, existing solutions are deficient in that currently instructors are unable to assess a level of understanding by students/learners as they are being instructed on a particular subject matter. Therefore, an instructor is unable to adapt/modify his or her explanation of the content or any particular portion thereof, due to a lack of understanding on the part of a group of students/learners. The instructor is further unable to propose/approve personalized alternative educational content to individual students/learners

### SUMMARY

Some embodiments relate to methods, apparatuses and/or computer program products to provide alternative educational content for personalized learning in a class situation, where inputs indicating a level of understanding of a learning object by a plurality of users are received. A local level of understanding and a global level of understanding may be determined, which are used as a basis for providing an alternative explanation of the learning object by the instructor and/or providing an alternative learning object/set of exercises personalized to the difficulties of each user.

In one example embodiment, the learning content management system includes a processor configured to determine a local level of understanding for a learning object based on a plurality of received inputs. The local level of understanding indicates a collective understanding level of the learning object by a plurality of users. Each of the plurality of received inputs indicates a level of understanding of the learning object by one of the plurality of users. The processor is further configured to determine a global level of understanding based on the determined local level of understanding.

In an alternative example embodiment, the learning content management system further includes an input database configured to store the plurality of received inputs. The processor determines the local level of understanding by performing a statistical analysis on the plurality of received inputs stored in the input database. The learning content management system further includes an instructor interface configured to communicate the determined local level of understanding of the plurality of users to an instructor. The instructor presents an alternative explanation for conveying the learning object upon the determined local level of understanding being less than a first threshold. The processor is further configured to select at least one of an alternative learning object and a set of exercises for conveying the learning object. The at least one of an alternative learning object and a set of exercises are to be provided to users having difficulties with the learning object, upon at least one of the determined local level of understanding being less than the first threshold and the instructor indicating that no time is left for the instructor to pursue the alternative explanation.

In an alternative example embodiment, the processor is further configured to determine a degree of similarity between the at least one of an alternative learning object and a set of exercises and the learning object based on at least a metadata descriptor of the learning object, a full text content of the learning object and a combination of the metadata descriptor and the full text content of the learning object. The processor selects the at least one of an alternative learning object and a set of exercises based on the degree of similarity.

In an alternative example embodiment, the processor is further configured to determine a score for the at least one of an alternative learning object or a set of exercises based on at least one of the global level of understanding, the degree of similarity, a rating from the plurality of users and a rating from the instructor. The processor is further configured to provide the at least one of an alternative learning object or a set of exercises to the users having difficulties with the learning object, upon at least one of the score for the at least one of an alternative learning object or a set of exercises being greater than a scoring threshold and the at least one of an alternative learning object or a set of exercises being approved by the instructor.

In yet another example embodiment, the method includes determining, at a processor, a local level of understanding for a learning object based on a plurality of received inputs, the local level of understanding indicating a collective understanding level of the learning object by a plurality of users, each of the plurality of received inputs indicating a level of understanding of the learning object by one of the plurality of users. The method further includes determining, at the processor, a global level of understanding based on the determined local level of understanding.

In an alternative example embodiment, the method includes storing the plurality of received inputs, and wherein the determining the local level of understanding includes performing a statistical analysis on the plurality of received inputs stored in an input database. The method further includes communicating the determined local level of understanding of the plurality of users to an instructor, the instructor presenting an alternative explanation for conveying the learning object upon the determined local level of understanding being less than a first threshold. The method further includes selecting at least one of an alternative learning object and a set of exercises for conveying the learning object. The at least one of an alternative learning object and a set of exercises are to be provided to users having difficulties with the learning object, upon at least one of the determined local level of understanding being less than the first threshold and the instructor indicating that no time is left for the instructor to pursue the alternative explanation.

In an alternative example embodiment, the method includes determining the first threshold according to at least one of a feedback inputted by the instructor, a number of users and an objective of the learning object.

In an alternative example embodiment, the method further includes determining a degree of similarity between the at least one of an alternative learning object and a set of exercises and the learning object based on at least a metadata descriptor of the learning object, a full text content of the learning object and a combination of the metadata descriptor and the full text content of the learning object. The selecting of the at least one of an alternative learning object and a set of exercises is based on the degree of similarity.

In an alternative example embodiment, the method includes determining a score for the at least one of an alternative learning object and a set of exercises based on at least one of the global level of understanding, the degree of similarity, a rating from the users and a rating from the instructor. The method further includes providing the at least one an alternative learning object and a set of exercises to the users having difficulties with the learning object upon at least one of the score for the at least one of an alternative learning object and a set of exercises being greater than a scoring threshold and the at least one of an alternative learning object and a set of exercises being approved by the instructor.

In yet another embodiment, the computer readable medium includes a computer program product. The computer program product includes instructions, which when executed by the processor, cause the processor to perform functions including determining a local level of understanding for a learning object based on a plurality of received inputs, the local level of understanding indicating a collective understanding level of the learning object by a plurality of users, each of the plurality of received inputs indicating a level of understanding of the learning object by each of the plurality of users. The functions performed by the processor further include determining a global level of understanding based on the determined local level of understanding.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 depicts a setting in which an example embodiment of a learning content management system may be utilized;

FIG. 2 depicts the learning content management system according to an example embodiment; and

FIG. 3 describes a process carried out by the components of the learning content management system, according to an example embodiment.

### DETAILED DESCRIPTION OF EXAMPLE EMBODIMENTS

Various embodiments will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This disclosure may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory content. Information, arguments, parameters, data, etc. may be passed, forwarded, or transmitted via any suitable means including memory sharing, message passing, token passing, network transmission, etc.

Example embodiments may be utilized in conjunction with RANs such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); Ultra Mobile Broadband (UMB); and 3rd Generation Partnership Project LTE (3GPP LTE).

Students/learners in a classroom setting may differ in their level of understanding of particular subject matter that is being explained by an instructor to the students/learners. Furthermore, without receiving sufficient and timely feedback, an instructor may never be able to obtain an accurate picture of the level of understanding of the students/learners individually or as a group until such time when the students/learners are examined on one or more topics. Receiving timely feedback and/or an assessment of each student/learner provides an enhanced opportunity for an instructor to present alternative/modified explanation for a particular topic or approve exercises and/or supplementary topics tailored to individual needs of students/learners who have indicated their respective difficulties with a particular subject matter.

FIG. 1 depicts a setting in which an example embodiment of a learning content management system may be utilized. An instructor 101 may be conducting a learning session within a classroom setting 100. The instructor may utilize a variety of teaching techniques such as a blackboard 102 to communicate content of a learning object to students/learners 103. The learning object may be an educational course including but not limited to topics on mathematics, science, art, literature, etc. Students/learners 103 may each utilize a device 104 to communicate their respective level of understanding to the instructor 101. The instructor 101 may receive a variety of feedback on students' individual/collective level(s) of understanding enabling the instructor 101 to modify or alter his or her explanation of the content. The instructor 101 may further be enabled, as a result of receiving the feedbacks, to approve tailored alternative learning objects and/or sets of exercises on a device 105.

The classroom setting 100 may be an actual classroom in an education institution such as a school, a college and a university. The classroom setting 100 may further be a classroom in a school, a conference room, an auditorium, a virtual classroom conducted online or any formal/informal place of gathering of learners/instructor(s). The device 104 may be any type of an electronic device capable of receiving an input and communicating data over a communication line, wired or wireless, to a server. The devices 104 and 105 may be any one of but not limited to a personal computer, a laptop, a tablet computer, a mobile device, a smart phone, a classroom clicker, etc.

Any one of the students/learners 103 in a classroom setting 100 may input his or her level of understanding of the learning object being discussed by the instructor 101 via the device 104. A particular student may for example enter an annotation including but not limited to “!” or “?”. “!” may indicate that the student is comfortable with the learning object being discussed while “?” may indicate that the particular student has not adequately understood the learning object. Students/learners 103 may further be able to enter text and thus with more particularity explain their exact difficulty with the learning object being discussed by the instructor. Furthermore, the inputting of a level of understanding may be initiated in real time by any one of the students/learners 103 as the instructor 101 is going through particular subject matter or a subsection of the subject matter. Alternatively, the instructor 101, at certain points, may initiate the inputting of the level of understanding during a discussion, for which the instructor 101 may pause and ask students/learners 103 to enter their respective level of understanding. Such certain points may be any one of but not limited to the end of a discussion of particular learning object or a segment thereof, as well as set times during the discussion, (e.g., every 15 minutes, every 20 minutes, etc).

FIG. 2 depicts the learning content management system according to an example embodiment. A processor 210 may be programmed to incorporate a variety of modules and/or computational units for carrying out underlying tasks including but not limited to determining a level of understanding, also known as a local level of understanding, for students/learners in a given classroom setting as described in FIG. 1, determining a collective level of understanding across several classroom settings also known as a global level of understanding, providing alternative learning objects and/or sets of exercises, and determining a score of the alternative learning objects and/or sets of exercises. As such, the processor 210 is a special purpose computer. Each of the modules may be located on a separate processor or may collectively be implemented on a single processor such as processor 210. The processor 210 along with databases 212, 217 and 218 may be located on a single server 211 or may each be located on a separate server. In case of being located on different servers, databases 212, 217 and 218 as well as the processor 210 may communicate over a wireless network or a wired network. The input device 204 may communicate with other components such as the local level of understanding computational module 213, an instructor interface 205 and databases 212 and 217 via a wireless and/or wired connection. Databases 212, 217 and 218 may be any one of but not limited to a magnetic memory or optical memory (e.g., a compact disk read only memory, or a solid state memory), etc.

The underlying functioning of each component depicted in FIG. 2 is hereinafter described with respect to FIG. 3. FIG. 3 describes a process carried out by the components of the learning content management system, according to an example embodiment.

As described above, each learner/student 103 may input his or her level of understanding of a learning object being discussed by an instructor, such as instructor 101 of FIG. 1, via his or her input device 204. Each of the inputs is then communicated to the server 210. The inputs are further communicated to the input database 212 where students' levels of understanding may be stored. Upon receiving inputs (S330), the server 210, via a computational module 213, determines a local level of understanding for one or more students/learners 103 in a given classroom setting with respect to a particular learning object being discussed by the instructor 101 (S331). The local LoU represents a collective understanding level of students/learners located in a classroom with regard to a learning object being discussed by the instructor. This computational module 213 may be referred to as a local LoU computational module 213. The local LoU may be calculated, for example, by performing a statistical analysis on the plurality of inputs received and stored in the database 212. The statistical analysis may be a ratio of each annotation, (e.g., “?” or “!”), to a total number of students/learners in a given classroom. In one example embodiment, there may be 20 learners/students in a given classroom setting, of which 12 have indicated their difficulty with the learning object or any portion thereof being discussed by the instructor 101. In this example, the LoU is equal to 12/20. The LoU may alternatively be expressed as a percentage, which in this example is equal to 60%.

The processor 210 may further determine, via a global LoU computational module 214, a global level of understanding of a particular learning object (S332). The global LoU is determined based on the local LoU. The processor may further store the plurality of inputs in the database 212 located on the server 211 (S333). In one example embodiment, the global LoU may be determined as a weighted average of all local LoUs, each of which is associated with a different classroom setting. The weighted average may be derived from a sum of all local LoUs divided by the total number of different classroom settings. For example, a first classroom setting of 20 students/learners may have a LoU of 60%, as described above. A second classroom setting of 30 students/learners may have a LoU of 30% and a third classroom setting of 10 students/learners may have a LoU of 50%. Therefore, the global LoU is determined by the sum of the LoUs divided by the number of classroom settings (e.g. (60%+30%+50%)/3)=46.66%).

Thereafter, the processor 210 compares the local LoU to a threshold (S334). The threshold may, for example, be a value below which the instructor may assume that the majority of students/learners have difficulties in understanding a particular learning object. The threshold may be a design parameter determined based on an empirical study which may take into account a variety of factors including but not limited to a feedback received from the instructor, the number of students/learners, an objective of a particulate learning object being discussed, a level of difficulty of the learning object, performance or LoU of the students/learners in related and/or past learning objects, etc. The threshold may then be programmed into the processor 210.

In one example embodiment, the instructor may specify that at least 50% of students must indicate that they have no difficulty with the learning object being discussed or otherwise an alternative explanation may be needed. In this instance the threshold is set at 50%, against which the local LoU and/or global LoU may be compared. In an alternative embodiment, a particular learning object may be so difficult that an average LoU for previous learners/students is at 25%. Accordingly, the threshold may be determined to be 25%, thus taking into account the level of difficulty of a particular learning object.

The local LoU being greater than the threshold may be representative of the fact that the majority of students/learners in a given classroom setting have not indicated a difficulty with the learning object being discussed by the instructor. Therefore, while there may be a minority of students/learners who may have difficulty with the learning object, because the majority have not indicated any difficulty, it may not be efficient for the instructor to spend time on presenting a modified version of his or her explanation of the learning object for the relatively small number of students/learners with difficulties. This inefficiency may be due to factors including but not limited to time constraints, the objectives of the learning object, the amount of material that need to be covered in a given session, in a given week, etc.

Therefore, instead of a modified explanation for students/learners with difficulties, the processor 210 may select an alternative learning object and/or a set of exercises to be presented individually to those students/learners who have indicated having difficulties with the learning object (S337). The processor 210 may select an alternative learning object and/or set of exercises randomly, based on an average of degrees of similarity (discussed below with relation to S338) determined for previously selected learning objects and/or sets of exercises or based on an average of scores (discussed below with relation to (S339) assigned to previously selected learning objects and/or sets of exercises. Alternatively, the processor 210 may select an alternative learning object and/or set of exercises based on a combination of the average degree of similarity and the average score.

Upon selecting an alternative learning object and/or a set of exercises, the processor 210 determines a degree of similarity between the learning object being discussed by the instructor and the selected alternative learning object and/or set of exercises (S338). The processor may determine the degree of similarity based on a metadata descriptor of the learning object, a full text content of the learning object or any combination of the metadata descriptor and the full text content of the learning object. In one example embodiment, the degree of similarity may be expressed on a scale of 0 to 10 with 0 indicating no or a minimal degree of similarity between the learning object being discussed and the selected alternative learning object and/or set of exercises, and 10 indicating a total or a very high degree of similarity between the learning object being discussed and the selected alternative learning object and/or set of exercises. Hereinafter, an example method for determining the degree of similarity is described.

The content of a learning object and/or set of a student's/learner's notes on the given learning object may be described by a vector of keywords extracted from a combination of the full text content represented by

$$desc ( {LO}_{i} ) = ( \begin{matrix}{C}_{1} \\ ⋮ \\ {C}_{n}\end{matrix} ) ,$$

and a metadata descriptor of the learning object, which may be data having a meaning in an ordered classification system. The degree of similarity between the learning object discussed (LOD) by the instructor and the selected alternative learning object and/or set of exercises (LOS) may be determined as a linear combination of similarities between the user's notes related to LOD and the LOS as well as the static description of LOD and LOS, where the static description may be composed from the metadata descriptor and a vector of extracted keywords/concepts. In one example embodiment, the linear combination may be expressed as:

sim(LObD,LOS)=a*sim({Inter.}LObD,LOS)+b*logicalLink(LObD,LOS)

### Where:

sim is a similarity measure, which may be based on any one of, but not limited to a cosine similarity, semantic similarity metrics, for example using the semantic structure such as hierarchies of concepts in WordNet, or statistical approaches, such as the normalized Google distance;
{Inter.}LObD is the representation of the set of users' notes in LObD (vector of keywords/concepts)
logicalLink is a similarity measure between the logical (metadata) and semantic properties (vector of extracted keywords) of both LOD and LOS. For example, the smaller the distance between metadata descriptors of the LOD and LOS, the more closely related the LOD and LOS are; and
a and b are variables enabling the balancing of the weight of the objects' logical link and the similarity of interactions.

The processor 210 may then determine a score for the selected alternative learning object and/or set of exercises (S339). The score may be based on any one of a number of factors including but not limited to the global level of understanding determined by the processor 210 in S332, the degree of similarity determined by the processor in S338, a student/learner rating of the learning object being discussed by the instructor, a rating of the selected alternative learning object and/or set of exercises by the instructor, etc. In an example embodiment, the processor may determine the score by comparing a degree of similarity computed for a selected alternative learning object and/or set of exercises with a database of degrees of similarity. Such database stores the top k degrees of similarities for previously selected alternative learning objects and/or sets of exercises, where k may be an integer programmed into processor 210 by an operator. Alternatively, the processor may dynamically learn an appropriate value for K.

In one example embodiment, the determined degree of similarity between the learning object and a currently selected alternative learning object and/or set of exercises may be 7, indicating a relatively acceptable similarity. Thereafter, the processor may search a database, which has previous degrees of similarity for other alternative learning objects and/or sets of exercises stored thereon. For example the database may have the highest three degrees of similarities determined previously. For example, these values may be 5, 7 and 9, an average of which is 7. Thereafter, by comparing the average of previous degrees of similarity and the degree of similarity of the currently selected alternative learning object and/or set of exercises, the processor may give the currently selected alternative learning object and/or set of exercises a score of 7.

Upon determining the score in S339, the processor compares the score to a scoring threshold known to the processor 210 (S340). The scoring threshold may be a design parameter determined based on an empirical study, which may take into account a variety of factors including but not limited to any one of statistics associated with the learning object being discussed by the instructor, goals of the learning object being discussed, feedback received from students/learners regarding alternative learning objects/sets of exercises previously extracted by the processor, past scores of extracted alternative learning objects/sets of exercises by various instructors, etc. The scoring threshold may then be programmed into the processor 210.

In one example embodiment, an average score of 8 may have been assigned to previously selected alternative learning objects and/or set of exercises. Therefore, if a given selected alternative learning object and/or set of exercises is given a score of 7, the processor may determine not to present the selected alternative learning object and/or set of exercises because the score for the selected alternative learning object and/or set of exercises is lower than the average score of previously selected alternative learning objects and/or sets of exercises. Alternatively, an instructor may set a scoring threshold and enter the scoring threshold into the system. At this point, the process may return back to S337.

Upon determining that the determined score of the selected alternative learning object/set of exercises is greater than the scoring threshold, the processor may then present the selected alternative learning object/set of exercises to the instructor for approval (S341). Upon either the score being less than the scoring threshold or the instructor not approving the selected alternative learning object/set of exercises, the process reverts back to S337 and steps S337 to S341 are repeated until both the score is higher than the scoring threshold and the selected alternative learning object/set of exercises is approved by the instructor.

Upon both the score being higher than the scoring threshold and the instructor approving the selected alternative learning object/set of exercises, the selected alternative learning object/set of exercises is provided to the individual users with difficulties (S342).

At S343, the processor 210, may store a list of students/learners who have indicated having difficulties with the learning object being discussed, in a user database 217, shown in FIG. 2. The processor 210 may further provide recommendations, at S344, to the instructor on grouping students/learners with similar difficulties based on the list of students/learners stored in the user database 217. Such grouping may be useful in setting up subsequent additional problem solving sessions, etc. Thereafter, the process may end.

In an alternative embodiment, any one of the score being higher than the scoring threshold or the instructor approving the alternative learning object/set of exercises, is sufficient for the processor to provide the selected alternative learning object/set of exercises to each student in S342 who have indicated a level of difficulty with the learning object being discussed by the instructor in a given classroom setting.

In an alternative example embodiment, the instructor may forego his or her ability to approve the selected alternative learning object/set of exercises. The instructor may do so by for example choosing a setting that requires the processor to bypass the instructor every time an alternative learning object/set of exercises has a score higher than the scoring threshold or may simply choose to ignore the approval request on a case by case basis upon the processor 210 presenting the instructor with the approval request on his or her instructor device, (e.g., device 105 shown in FIG. 1).

Referring back to S337 and in an alternative example embodiment, the processor may only choose a set of exercises and repeat the process described in S338 to S342. The processor may then use a variety of information/feedback associated with the selected set of exercises to better select an alternative learning object to be presented to any one of the students/learners. Such information/feedback may be any one of the degree of similarity determined with respect to the set of exercises, the determined score of the set of exercises, the approval received from the instructor, a feedback received from the students/learners to whom the set of exercises are presented, and the outcome of the set of exercises after being completed by the students/learners. According to this alternative embodiment, the processor is further capable of selecting the alternative learning object more accurately in order to address the shortcomings/difficulties of any one of the students/learners to whom the set of exercises is presented.

Referring back to S334 wherein the processor compares the local LoU to the threshold, if the local LoU is less than the threshold, then the processor may notify the instructor that an alternative explanation of the learning object being discussed may be needed (S335). The local LoU being less than the threshold may indicate that the majority of students/learners in the classroom setting have indicated difficulties with the learning object being discussed.

Thereafter, the processor may prompt the instructor, via the instructor device 105, to indicate whether the instructor has sufficient time to present an alternative explanation of the learning object being discussed (S336). In an alternative embodiment, the instructor may, at his or her own initiation, indicate that no sufficient amount of time is left for the instructor to present an alternative explanation. Upon receiving such indication, the process reverts back to S337 and steps S337 to S342, as described above, are repeated.

However, if the instructor indicates that sufficient time for presenting an alternative explanation exists, the instructor may do so at his or her own discretion. Thereafter, the process may end.

Alternatively, prior to presenting the alternative explanation, the instructor may ask the system to provide quick and short exercises to be presented to students/learners in an attempt to better identify particular problems that the students/learners may have with the learning object being discussed. For example, the instructor may request the system to retrieve quick exercises directed to main topics being discussed by the instructor in order to determine whether the main topics and/or other subtleties and finer point need to be re-explained. The processor, upon receiving the instructor's request for such exercises, may refer to the exercise database 218, shown in FIG. 2, to retrieve the exercises.

In yet another example embodiment, local and global LoUs may also be stored in a database such as the user database 217. In one scenario, at a conclusion of each classroom session an instructor may be able to retrieve a plurality of data such as the list of students with difficulties and the students' levels of understanding from the user database 217 as well as the inputs stored in the input database 212, and analyze the data.

The system may present the instructor with visual illustrations regarding, for example, collective progress of the students/learners from one session to another, statistical data on which learning objects received more indications of difficulties than others, which students indicated difficulties with regard to different learning objects, etc. Such data may be presented with regard to individual session, sessions in a week, session in a month, throughout a semester, throughout an academic year, etc. The instructors may be able to create a profile with the system indicating their respective preference with regarding to the analysis of the data, as described above. For example, they may indicate what visual illustrations they need, what type of data they need to track, etc. Such data and/or analysis may further be useful to the instructors in determining how to break-up the students with similar difficulties and/or levels of understanding into smaller groups for extra activities such as problem solving sessions, discussion sessions conducted by teachings assistants, etc. Furthermore, the system may enable different instructors to collaborate among one another, exchange data and/or assist one another in improving the quality of their learning objects.

Variations of the example embodiments are not to be regarded as a departure from the spirit and scope of the example embodiments, and all such variations as would be apparent to one skilled in the art are intended to be included within the scope of this disclosure.

What is claimed:

1. A learning content management system comprising:
a processor configured to,
determine a local level of understanding for a learning object based on a plurality of received inputs, the local level of understanding indicating a collective understanding level of the learning object by a plurality of users, each of the plurality of received inputs indicating a level of understanding of the learning object by one of the plurality of users, and
determine a global level of understanding based on the determined local level of understanding.

2. The learning content management system of claim 1, wherein at least one of the plurality of inputs includes at least one of an annotation or a text illustrating whether a user has difficulty in understanding the learning object.

3. The learning content management system of claim 2, wherein
a ? annotation indicates that the user has difficulty with the learning object, and
a ! annotation indicates that the user has no difficulty with the learning object.

4. The learning content management system of claim 1, further comprising:
an input database configured to store the plurality of received inputs, and wherein the processor determines the local level of understanding by performing a statistical analysis on the plurality of received inputs stored in the input database; and
an instructor interface configured to communicate the determined local level of understanding of the plurality of users to an instructor, the instructor presenting an alternative explanation for conveying the learning object upon the determined local level of understanding being less than a first threshold, and wherein the processor is further configured to select at least one of an alternative learning object and a set of exercises for conveying the learning object, the at least one of an alternative learning object and a set of exercises to be provided to users having difficulties with the learning object, upon at least one of the determined local level of understanding being less than the first threshold and the instructor indicating that no time is left for the instructor to pursue the alternative explanation.

5. The learning content management system of claim 4, wherein the processor determines the first threshold according to at least one of a feedback inputted by the instructor, a number of users and an objective of the learning object.

6. The learning content management system of claim 4, wherein
the processor is further configured to determine a degree of similarity between the at least one of an alternative learning object and a set of exercises and the learning object based on at least a metadata descriptor of the learning object, a full text content of the learning object and a combination of the metadata descriptor and the full text content of the learning object, and
the processor selects the at least one of an alternative learning object and a set of exercises based on the degree of similarity.

7. The learning content management system of claim 6, wherein the processor is further configured to
determine a score for the at least one of an alternative learning object or a set of exercises based on at least one of the global level of understanding, the degree of similarity, a rating from the plurality of users and a rating from the instructor; and
provide the at least one of an alternative learning object or a set of exercises to the users having difficulties with the learning object, upon at least one of the score for the at least one of an alternative learning object or a set of exercises being greater than a scoring threshold and the at least one of an alternative learning object or a set of exercises being approved by the instructor.

8. The learning content management system of claim 1, further comprising:
a user database configured to store a list of users having difficulties with the learning object; and wherein
the processor is further configured to provide a recommendation to an instructor for grouping the plurality of users into different groups according to the level of understanding of each of the plurality of users.

9. The learning content management system of claim 1, further comprising:
an input device configured to receive the plurality of inputs at any time during a discussion of the learning object by an instructor or at a conclusion of the discussion.

10. The learning content management system of claim 1, wherein the processor is further configured to adjust the global level of understanding of the learning object based on any subsequent determination of additional local levels of understanding of the learning object by the processor.

11. The learning content management system of claim 1, wherein
the learning object is a topic associated with a particular educational course,
the plurality of users are students in a given classroom, and
the global level of understanding indicates an overall understanding level of the topic by students in different classrooms, students in each one of the classrooms being taught by a different instructor.

12. A method comprising:
determining, at a processor, a local level of understanding for a learning object based on a plurality of received inputs, the local level of understanding indicating a collective understanding level of the learning object by a plurality of users, each of the plurality of received inputs indicating a level of understanding of the learning object by one of the plurality of users; and
determining, at the processor, a global level of understanding based on the determined local level of understanding.

13. The method of claim 12, wherein at least one of the plurality of inputs includes at least one of an annotation or a text illustrating whether a user has difficulty in understanding the learning object.

14. The method of claim 13, wherein
a ? annotation indicates that the user has difficulty with the learning object,
and
a ! annotation indicates that the user has no difficulty with the learning object.

15. The method of claim 12, further comprising:
storing the plurality of received inputs, and wherein the determining the local level of understanding includes performing a statistical analysis on the plurality of received inputs stored in an input database;
communicating the determined local level of understanding of the plurality of users to an instructor, the instructor presenting an alternative explanation for conveying the learning object upon the determined local level of understanding being less than a first threshold; and
selecting at least one of an alternative learning object and a set of exercises for conveying the learning object, the at least one of an alternative learning object and a set of exercises to be provided to users having difficulties with the learning object, upon at least one of the determined local level of understanding being less than the first threshold and the instructor indicating that no time is left for the instructor to pursue the alternative explanation.

16. The method of claim 15, further comprising:
determining the first threshold according to at least one of a feedback inputted by the instructor, a number of users and an objective of the learning object.

17. The method of claim 15, further comprises:
determining a degree of similarity between the at least one of an alternative learning object and a set of exercises and the learning object based on at least a metadata descriptor of the learning object, a full text content of the learning object and a combination of the metadata descriptor and the full text content of the learning object, and wherein
the selecting the at least one of an alternative learning object and a set of exercises is based on the degree of similarity

18. The method of claim 17, further comprising:
determining a score for the at least one of an alternative learning object and a set of exercises based on at least one of the global level of understanding, the degree of similarity, a rating from the users and a rating from the instructor; and
providing the at least one an alternative learning object and a set of exercises to the users having difficulties with the learning object upon at least one of the score for the at least one of an alternative learning object and a set of exercises being greater than a scoring threshold and the at least one of an alternative learning object and a set of exercises being approved by the instructor.

19. The method of claim 12, further comprising:
storing a list of users having difficulties with the learning object, and
providing a recommendation to the instructor for grouping the plurality of users into different groups according to the level of understanding of each of the plurality of users.

20. The method of claim 12, wherein the plurality of inputs are received at any time during a discussion of the learning object by an instructor or at a conclusion of the discussion.

21. The method of claim 12, wherein the determining the global level of understanding includes adjusting the global level of understanding of the learning object based on any subsequent determination of additional local levels of understanding of the learning object.

22. The method of claim 12, wherein
the learning object is a topic associated with a particular educational course,
the plurality of users are students in a given classroom, and
the global level of understanding indicates an overall understanding level of the topic by students in different classrooms, students in each one of the classrooms being taught by a different instructor.

23. A non-transitory computer-readable medium including a computer program product, the computer program product comprising instructions, which when executed by a processor, causes the processor to perform functions including:
determining a local level of understanding for a learning object based on a plurality of received inputs, the local level of understanding indicating a collective understanding level of the learning object by a plurality of users, each of the plurality of received inputs indicating a level of understanding of the learning object by each of the plurality of users; and
determining a global level of understanding based on the determined local level of understanding.
